(19) United States
(12) Patent Application Publication
(10) Pub. No.: US 2024/0210110 A1
(43) Pub. Date: Jun. 27, 2024

(54) METHODS FOR THE ESTIMATION OF SURFACE WATER ACTIVITY IN PRODUCTS BEING DRIED

(71) Applicant: VISCOFAN TECHNOLOGY (SUZHOU) CO., LTD., Suzhou, Jiangsu (CN)

(72) Inventors: Carlos M. Longo, Suzhou, Jiangsu (CN); Juan Negri Samper, Suzhou, Jiangsu (CN)

(73) Assignee: VISCOFAN TECHNOLOGY (SUZHOU) CO., LTD., Suzhou, Jiangsu (CN)

(21) Appl. No.: 18/286,807

(22) PCT Filed: Apr. 8, 2022
(86) PCT No.: PCT/EP2022/059449

§ 371 Date: Oct. 13, 2023

(30) Foreign Application Priority Data
Apr. 15, 2021 (CN) 2021104049074

(51) Int. Cl. F26B 21/08; A23B 4/03; F26B 21/10; F26B 25/22

(52) U.S. Cl. CPC F26B 21/08; F26B 21/10; F26B 25/22; A23B 4/031

(57) ABSTRACT

Dryer and methods for estimating the surface water activity aws of products being dried. wherein the dryer comprises at least one relative humidity HR probe of the dryer atmosphere and a temperature probe.

### OBJECT OF THE INVENTION

The object of the present invention relates to methods for estimating surface water activity in products being dried and drying facilities that implement said methods.

### BACKGROUND OF THE INVENTION

Air drying is used in many products. For example, in foods, such as cheeses, and particularly in sausages, especially in cured sausages. For example, sausages such as salamis are subjected to long, highly controlled drying processes in drying chambers, until the desired degree of curing is achieved. It is essential to control the ripening and drying process in these chambers, to finally obtain sausages with optimal characteristics.

For the preparation of salami, for example, the meat mixture is first prepared with the desired additives, and it is stuffed, for example, into high-caliber casings. The meat product originally has a high water activity (aw), which must be gradually and continuously lowered until obtaining a low aw meat product that is already preserved and is microbiologically stable. The drying process must be carried out according to a very careful protocol of time, temperature (T) and relative humidity (HR %) of the chambers to guarantee a gradual drying of the product, since if it is not well controlled, the defect called “crusting” can occur. Indeed, the aim is that drying is as fast as commercially possible, for example, weeks or months, but that this speed of drying does not lead to the surface of the sausage drying out too much, preventing the core of the sausage from drying out gradually as well.

For a body in contact with a certain atmosphere to be able to dry out, it is necessary that the aw of said body (for example, aw≈0.56) is greater than HR % of the atmosphere in contact, for example 50% HR or put in equivalent form of so much by one to compare with aw≈0.50. In this case there will be a desiccation of the body by the atmosphere, until in equilibrium aw is identical on both sides. For example, if said body has very little mass and is placed with an unlimited reserve of atmospheric air with a HR % of 50% (equivalent to a aw≈0.50), finally the body will dry out to aw≈0.50, to put itself in equilibrium with said atmosphere 50% HR. That would be the case with a fine body of constant aw.

However, in a body on drying such as a thick sausage such as salami, in which the drying process can take for example 28 days, there may be a whole gradient of aw values inside it, from aw of the core of the Salami (which will initially be very similar to the initial aw of the sausage meat product) to that aw of the surface (aws) of the salami (which will tend to be in equilibrium with the aw of the atmosphere with which it is in contact). This gradient is dynamic, depending on the drying of the surface layers with their lowering of aw, it pushes the drying of the internal adjacent layers, causing a net movement towards the outside and therefore a net drying. The profile of aw inside the sausage changes during drying and depends on the history of the drying process that has been carried out, it is therefore not static and follows a gradual and dynamic process.

The driving force of the drying process is the existing gradient of aw between the aw of the atmosphere and the aw of the sausage, so that when said gradient is 0, that is:

$$aw of atmosphere \approx aw of sausage$$

both components (atmosphere and sausage) will be in equilibrium and there will not be a net flow of matter between them. While if:

$$aw of atmosphere << aw of sausage ,$$

There will be a strong drying of the sausage towards the atmosphere, much greater the greater the net difference between both aw in contact. In this process, the aw of the sausage that is relevant to this effect is the aw of the surface of the sausage (aws), since it is this area that is in contact with the atmosphere. While the aw inside of the sausage (for example, the core of the sausage) does not interact directly with the aw outside atmosphere, only indirectly and slowly by diffusion through all the internal layers of the sausage.

Therefore, to follow the drying process of products such as sausage, it is important to control the following terms:
aw of the atmosphere in contact with the surface of the sausage.
aw of the surface of the sausage (aws).

In the classic manufacture of sausages, the sausage drying process was controlled in an artisanal way by the sausage manufacturer, who constantly monitored the apparent degree of dryness of the sausage and the desiccant atmosphere, and acted, for example, by opening and closing the windows of the drying chamber to speed up or slow down the drying process, all in an empirical and traditional way.

Already in modern times, this process has begun to be controlled much more rigorously with technical means.

For example, the first term (aw of atmosphere), can be measured continuously by means of probes of HR %, for example, sensors inside the drying chambers, they measure the HR % and the temperature (T) of the air and record it throughout the process.

However, for the second term, the measurement of the sausage aws is not as simple as in the previous case. Indeed, while thermo-hygrometric probes continuously record in an easy way the T and HR % of an air sample, said probes shall, for example, come into contact with the surface of the sausage in order, after an equilibrium process, to provide the equilibrium HR % of the air chamber between probe and product. Then the probe must be removed, since it is interfering in the drying process of the sausage surface itself, before taking another measurement. This makes the sausage aws measurement complex and difficult to carry out, especially continuously.

Thus, in order to follow the drying process it is desired to obtain a simple and quick method of estimating the aws of the product being dried. The present invention satisfies this demand.

### DESCRIPTION OF THE INVENTION

The advantages of the invention are:
The aws of the product being dried can be estimated with a conventional HR % probe of the drying oven, not being necessary an expensive surface probe for the sausage.
The process is simple and takes little time, so it can be used to control the drying process of products, especially food, and especially sausages, especially cured sausages.
In the process of the invention, complicated measurements of the meat product are not used, for example, such as the measurement of the surface temperature by infrared probes, or the measurement of the aws by surface hygrometric probes, or of the heat flow, but rather advantageously, the usual instruments of dryers, such as the interior temperature and HR % probes of the dryer atmosphere, to indirectly estimate parameters corresponding to the product, such as the aws of the product and the evaporation rate (TE), which can help to monitor and control an adequate drying and maturation process of, for example, salamis.

Thus, in a first aspect, the present invention relates to a method for estimating the surface water activity aws of a food product being dried in a dryer, the process comprises the following steps carried out by computational means:

obtaining a plurality of relative humidity HRi and/or absolute humidity Habsᵢ values of the dryer atmosphere at time points ti during the product drying process and obtaining a set of representative relative humidity HRri values based on the relative humidity HRi values during the drying process of the product.

The method further comprises obtaining a set of evaporation rate values TEᵢ based on the set of HRᵢ (%) and/or Habsᵢ and ti values.

The method also includes obtaining the regression line of the function F(α,β)=F(HRri,TEᵢ), such that

$$α = HReq , β = 0 \\ β = TEmáx , α = 0$$

In a preferred embodiment, the variable α is represented on the X coordinate axis, and the variable β is represented on the γ coordinate axis, such that:

F(X,Y)=F(HRri,TEᵢ), wherein:

$$X = HReq , Y = 0 \\ Y = TEmáx , X = 0$$

wherein HReq is the relative humidity when the air and the surface of the product being dried are in equilibrium and wherein TEmáx is the maximum evaporation rate when the HR of the air in the dryer is zero, and

The method finally includes estimating the aws value of the product being dried based on HReq, such that:

$$aws = \frac{HReq}{100}$$

In a second aspect, the present invention relates to a dryer for estimating the surface water activity aws of food products being dried, wherein the dryer comprises at least one relative humidity probe HR % of the dryer atmosphere and a temperature probe, and computational means configured to obtain by means of the probes a plurality of relative HRi and/or absolute Habsᵢ humidity values of the dryer atmosphere at time points during the product drying process. 25 In addition, the computational means are configured to obtain a set of representative values of the relative humidity HRᵣᵢ (%).

Furthermore, the computational means are configured to obtain a set of evaporation rate values TEᵢ based on the set of HRi and/or Habsᵢ and ti values.

In addition, the computational means are configured to obtain the regression line of the function F(α,β)=F(HRri,TEᵢ), such that:

$$α = HReq , β = 0 \\ β = TEmáx , α = 0$$

In a preferred embodiment, the variable α is represented on the X coordinate axis, and the variable β is represented on the Y coordinate axis, such that:

F(X,Y)=F(HRri,TEᵢ), wherein:

$$X = HReq , Y = 0 \\ Y = TEmáx , X = 0$$

Wherein HReq is the relative humidity when the air and the surface of the product being dried are in equilibrium, wherein TEmáx is the maximum evaporation rate if the HR of the air in the dryer is zero, and

In addition, the computational means are configured to obtain the aws value of the product being dried based on HReq, such that:

$$aws = \frac{HReq}{100}$$

In a preferred embodiment, the set of representative relative humidity values HRᵣᵢ (%) corresponds to:

$${HR}_{ri} ( \% ) = ( {HR}_{i} + {HR}_{i + 1} ) / 2$$

In a preferred embodiment, the set of representative relative humidity values HRᵣᵢ (%) corresponds to:

$${HR}_{ri} ( \% ) = {HR}_{i} ; o \\ {HR}_{ri} ( \% ) = {HR}_{i + 1}$$

In a preferred embodiment, the set of representative relative humidity values HRᵣᵢ (%) corresponds to:

$${HR}_{ri} ( \% ) = Me ( {HR}_{i} + {HR}_{i + 1} … {HR}_{i + N} ) ;$$

wherein Me e is the arithmetic mean; and
wherein N is an integer, for example, N=100.

In a preferred embodiment, the set of evaporation rate values TE corresponds to:

$${TE}_{i} = ( {HR}_{i + 1} - {HR}_{i} ) / ( {t}_{i + 1} - {t}_{i} ) ; o$$

$${TE}_{i} = ( H {abs}_{i + 1} - H {abs}_{i} ) / ( {t}_{i + 1} - {t}_{i} ) .$$

### Other Variants of the Invention:

Although the invention especially describes applications in the field of maturing meat products, for example salamis, the method described is also applicable to controlling the drying of products in general, such as dried food, powders, wood, paper, etc. etc.

Although long drying time applications are described in the invention, for example weeks, the described method is also applicable to controlling the drying in much shorter periods, for example hours or minutes, just adjusting measurement ranges accordingly.

Although the invention describes in detail drying applications with loss of product weight, it can also be applied for the opposite process, that is, weight gain, or even both, that is, processes that undergo drying phases and other phases otherwise.

Preferably, the process according to the present invention can be used in selected intervals having comparable conditions (for example of air flow) and with closed systems that are not carrying out a mass exchange with the outside, for example, by exit or inlet of external air to the dryer or condensation. If not, the results may be less accurate.

### DESCRIPTION OF THE DRAWINGS

To complement the description that is being made and in order to help a better understanding of the features of the estimation method, according to a preferred example of practical implementation thereof, a set of drawings is attached as an integral part of said description wherein, for illustrative and non-limiting purposes, the following has been represented:

FIG. 1 shows a period of the evolution of temperature, relative humidity and air speed at the lower edge of the dryer during the drying process.

FIGS. 2 to 4 show a graphical representation of the data obtained from a first range of values of the period of FIG. 1.

FIGS. 5 to 7 show a graphical representation of the data obtained from a second interval of values of the period of FIG. 1.

FIG. 8 shows a 3D graph of a set of regression lines obtained with the method according to the present invention.

### PREFERRED EMBODIMENT OF THE INVENTION

### Example 1

### Measurement Phase:

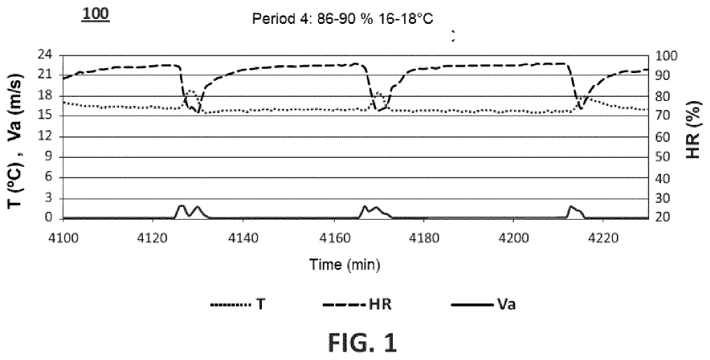

FIG. 1 shows a graph (100) of the evolution of temperature, relative humidity, air speed at the lower edge of the dryer in each period of the drying process of a meat product. In particular, FIG. 1 corresponds to “Period 4: 86-90% 16-18 ° C.” of the drying process.

For an example, the data interval between Times: 4132-4162.5 minutes shown in graph (100) of FIG. 1 is selected, and the following detailed points are selected in Table 1. The time data in minutes are converted into time in hours.

TABLE 1

| Point No | Situation | t (hours) | T (° C.) | RH (%) | Vair (m/s) |
|---|---|---|---|---|---|
| 1 | 1 | 68.87 | 15.64 | 82.08 | 0.075 |
| 2 | 2 | 68.89 | 15.74 | 85.35 | 0.075 |
| 3 | 3 | 68.97 | 15.81 | 90.10 | 0.077 |
| 4 | 4 | 69.03 | 15.94 | 92.19 | 0.079 |
| 5 | 5 | 69.08 | 15.94 | 93.15 | 0.081 |
| 6 | 6 | 69.21 | 16.00 | 92.82 | 0.084 |
| 7 | 7 | 69.37 | 15.83 | 93.98 | 0.089 |

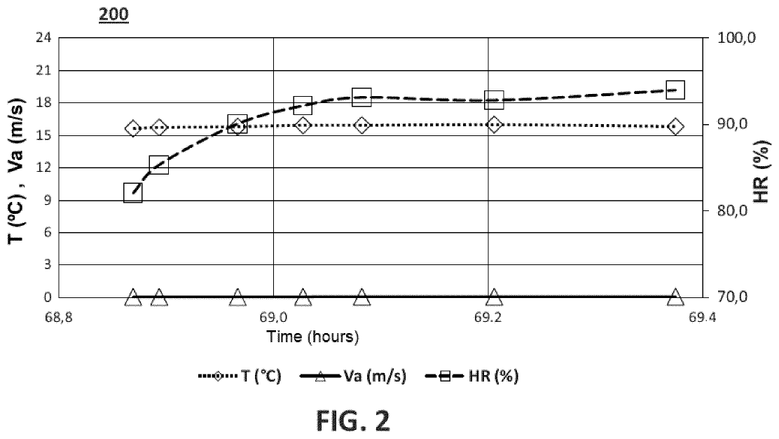

The data in table 1 are represented in graph (200) of FIG. 2.

### Calculation Phase:

From the data in Table 1, the consecutive intervals between one measurement point and the next one are selected. Interval 1 corresponds to points 1 and 2, (between time t1 and time t2), Interval 2 corresponds to points 2 and 3, and so on.

As HRr representative of each interval, the average of HR of each point and the next one is selected. For example, in the case of Interval 1:

$$HRr = ( HR 1 + HR 2 ) / 2$$

In other embodiments, HRr may be another representative relative humidity value, rather than the average, for example:

$$HRr = HR 1 ;$$

$$or$$

$$HRr = HR 2 ;$$

or

The arithmetic mean Me of a set of values of HR.

As TE representative of each interval, the quotient value, of the differences between HR and t of one point and the next one, is selected in this example. For example, in the case of Interval 1,

$$TE 1 = ( HR 2 - HR 1 ) / ( t 2 - t 1 )$$

Data in Table 2 are thus obtained:

TABLE 2

| Interval | Between points | HRr (%) | $TE ( \frac{HR}{hour} )$ |
|---|---|---|---|
| 1 | 1-2 | 83.71 | 134.40 |
| 2 | 2-3 | 87.72 | 64.94 |
| 3 | 3-4 | 91.14 | 34.41 |
| 4 | 4-5 | 92.67 | 17.48 |
| 5 | 5-6 | 92.98 | −2.70 |
| 6 | 6-7 | 93.40 | 6.90 |

### Representation and Estimation Phase:

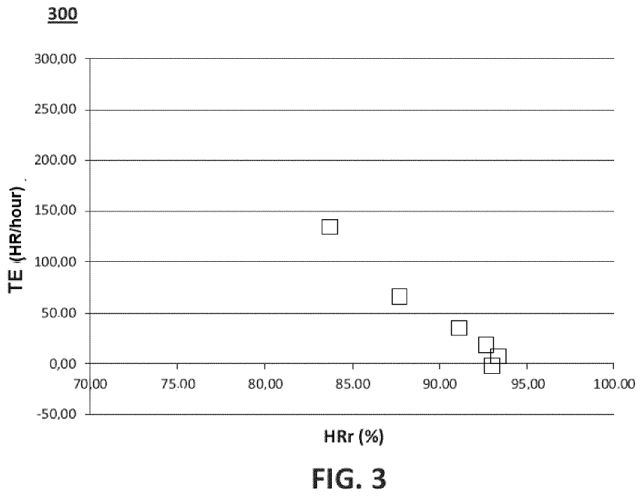

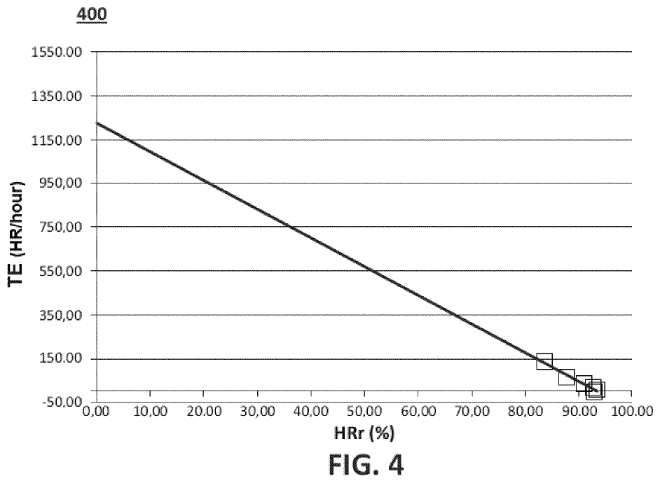

In FIG. 3 the data in Table 2 is represented in a graph (300), x-y graph, wherein HRr is represented as x variable, and TE as y variable. In the graph (400) of FIG. 4 the regression line of said data from Table 2 has also been added.

By extrapolation of said regression line until cutting the X and Y axes, the following points are obtained:
Cut with the X Axis: the HReq value is obtained from x-y coordinates:

$$X = HReq = 93.4 \% ,$$

$$Y = 0$$

Cut with the Y Axis: the TEmax value is obtained from x-y coordinates:

$$X = 0 ,$$

$$Y = TE max = 1228.1$$

### Parameter Estimates:

The aws estimated value of the surface of the product being dried, corresponds to the HReq value of the air obtained in the previous step, expressed on a per unit basis:

$$HReq = 93.4 \%$$

$$aws = \frac{93.4}{100} = 0.934$$

Interpretation: In this case, it has been determined that the aws of the product being dried has an approximate value of 0.934, since TE would decrease to zero when the HR of the air in the dryer was at 93.4%, and both components: air and surface of the product being dried, would be in equilibrium without a net evaporation of one to another of the components. At this point of equilibrium, both values aws and HReq would coincide, one of them corresponding to the surface of the sausage, and the other to the air of the dryer. Thus, with the method according to the present invention, the aws of the product being dried has been estimated, indirectly without measuring it directly, through the air parameters of the dryer.

The value of the TE at each point of HRr, can be obtained by extrapolation on the regression line obtained.

The estimated value of the maximum TE corresponds to the TEmáx value obtained in the graph (300):

$$TE max = 1228.1$$

In this case the units of TEmáx correspond to

$$\frac{HR}{hour} .$$

Interpretation: TEmáx corresponds to the TE that would be achieved if the HR % of the air of the dryer were set to HR=0%. In this case, TE would be the maximum that can be achieved (with the rest of the conditions unchanged) if completely dry air (HR=0%) were used in the dryer. An abnormally low value of TEmáx, could indicate that the surface of the product being dried is very dry, and that even if the air in the dryer were set to HR=0%, the rate of evaporation of the product being dried would be greatly reduced, and it would only be capable of increasing HR of the air of the dryer very slowly (very low TE).

### Example 2

### Measurement Phase:

The data interval between the times: 4173.5-4211.5 minutes of the “Period 4: 86-90% 16-18° C.” shown in the graph (100) of FIG. 1 is selected and the following detailed points are selected in Table 3. The data for t (minutes) are converted into t in hours.

TABLE 3

| | | t | T | HR | Vair | Habs |
|---|---|---|---|---|---|---|
| Point No | Situation | (hours) | (° C.) | (%) | (m/s) | (g/m3) |
| 1 | 1 | 69.56 | 15.66 | 81.70 | 0 | 11.47 |
| 2 | 2 | 69.60 | 15.82 | 88.43 | 0 | 12.54 |
| 3 | 3 | 69.61 | 15.84 | 90.71 | 0 | 12.88 |
| 4 | 4 | 69.62 | 15.79 | 91.17 | 0 | 12.90 |
| 5 | 5 | 69.64 | 15.68 | 92.92 | 0 | 13.05 |
| 6 | 6 | 69.70 | 15.89 | 92.93 | 0 | 13.24 |
| 7 | 7 | 70.19 | 15.76 | 95.23 | 0.05 | 13.45 |

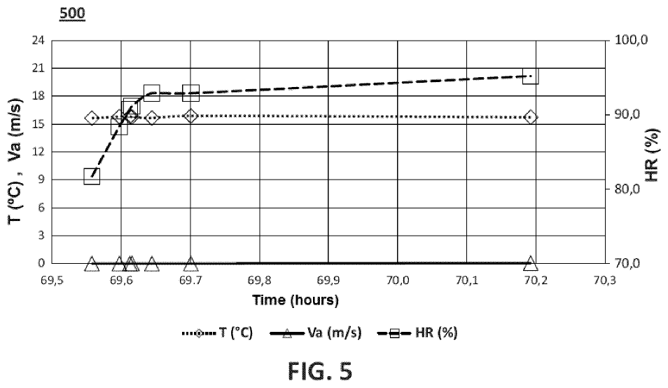

FIG. 5 shows a graph (500) with the values of Table 3.

### Calculation Phase:

From the data in Table 3, the consecutive intervals between one point and the next one are selected. Interval 1 corresponds to points 1 and 2, (between time t1 and time t2), Interval 2 corresponds to points 2 and 3, and so on.

As HRr representative of each interval, the average of HR of each point and the next one is selected. For example, in the case of Interval 1,

$$HRr = ( HR 1 + HR 2 ) / 2$$

In this example 2 additional data is considered, demonstrating the versatility of the method of the invention.

From the HR and T(°C.) values, Habs (g/m3) of the air is calculated, by means of the usual psychrometric equations. These values are included as an additional column in Table 3.

As TE representative of each Interval, the value of the quotient is selected in this example 2, of the differences between Habs and t of one point and the next one. For example, in the case of Interval 1,

$$TE = ( H abs 2 - H abs 1 ) / ( t 2 - t1 ) .$$

Data in Table 4 are thus obtained:

TABLE 4

| | Between | HRr | TE |
|---|---|---|---|
| Interval | points | (%) | (g/m3/h) |
| 1 | 1-2 | 85.06 | 27.04 |
| 2 | 2-3 | 89.57 | 22.27 |
| 3 | 3-4 | 90.94 | 9.06 |
| 4 | 4-5 | 92.05 | 5.17 |
| 5 | 5-6 | 92.92 | 3.27 |
| 6 | 6-7 | 94.08 | 0.42 |

### Representation and Estimation Phase:

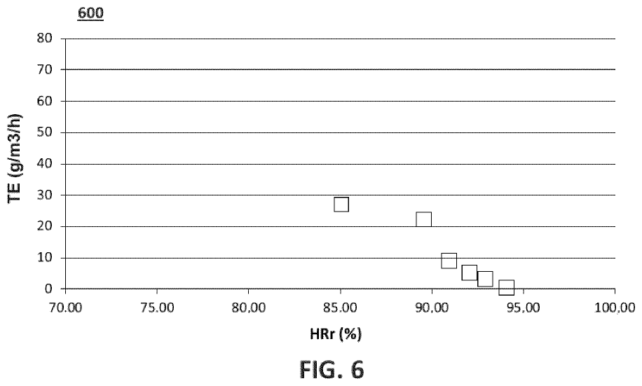

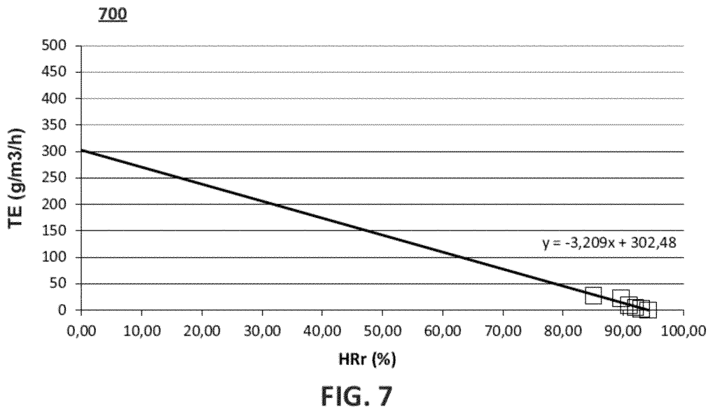

In a graph (600) of FIG. 6, x-y graph, the data of Table 4 are represented:
HRr as variable x;
TE as variable y;
In e graph (700) of FIG. 7 the regression line of said data has also been added.

By extrapolation of said regression line until cutting the X and Y Axes, the following points are obtained:
Cut with the X Axis: the Hreq value is obtained, from x-y coordinates: X=HReq=93.9%, Y=0.
Cut with the Y Axis: the TEmax value is obtained from x-y coordinates: X=0, Y==302.48.

### Parameter Estimates:

The estimated aws value of the surface of the product being dried, corresponds to the HReq value of the air obtained in the previous step, expressed on a per unit basis:

$$HReq = 93.9 \%$$

$$aws = \frac{93.9}{100} = 0.939$$

Interpretation: in this case it has been determined that the aws of the product being dried would have an approximate value of 0.939, since TE would decrease to zero when HR of the air of the dryer was at a HR of 93.9%, and both components, air and surface of the product being dried, would be in equilibrium without a net evaporation of one to another of the components. At that point of equilibrium, both values aws and HReq would match.

The TE value at each point of HRr, can be obtained by extrapolation on the Regression Line obtained.

The estimated value of the Maximum Evaporation Rate corresponds to the TEmáx value obtained in graph (700):

$$TE máx = 302.48$$

In this case the units of TE and TEmáx correspond to (g/m3/h), of increment per hour, of the g evaporates contained by m3 of air of the dryer. This allows a quantitative estimate of the current TE and TEmáx.

Interpretation: TEmax corresponds to the TE that would be achieved if HR of the air dryer were set to 0%. In this case, TE would be the maximum that can be reached (with the rest of the conditions unchanged) if completely dry air (HR=0%) were used in the dryer. An abnormally low TEmax value, could be indicative that the Sausage Surface is very dry, and that even if the air in the Dryer were at 0% HR, the rate of evaporation of the product being dried would be very slow, and it would only be able to increase HR of the air of the Dryer very slowly (very low TE).

If, in addition, the producer of the product being dried, for example, salamis, introduces additional data of its process such as:
the air volume of the dryer,
the total mass of sausage placed in the dryer
the composition of the sausage mass
the total surface of the sausage this would make it possible to make additional quantitative estimates of its process, such as total mass evaporated per hour, daily sausage weight loss, evaporation in kg/m2/day, etc. in a simple way.

### Example 3

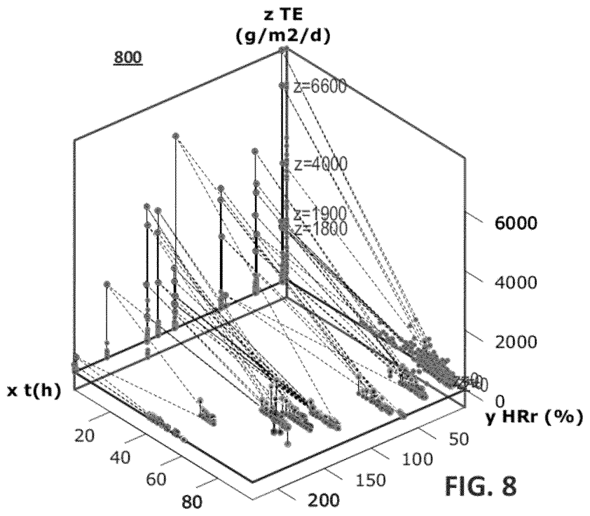

FIG. 8 shows a 3D graph (800) of a set of regression lines of the data obtained by means of the method of the present invention. These regression lines generate the following partial traces:

On the XY plane, the cut-off points of HReq, indicate the trace of the evolution of aws with respect to time, which is similar to that which would be obtained by making direct specific measurements of the sausage in the different phases of the drying process. The product begins with a high level aws, close to aw of meat emulsion, and gradually decreases until it stabilizes at the end aw of the product being dried, for example a dried meat product.

On the XZ plane, the cut-off points of TEmax, draw the trace of the evolution of TEmax with respect to time, said trace is similar to the graph of the evolution of the drying rate with respect to time. TE max is initially very high and is maintained while the internal contribution quickly contributes enough mass for its evaporation. From a certain point (analogous to the critical drying point), the maximum drying rate TEmax begins to decrease since the internal contribution is not capable of contributing enough mass to the surface to evaporate, until TE finally reaches very low values when the product is practically dry and in equilibrium with the storage atmosphere.

On the YZ plane, the regression lines obtained by the process of the invention are superimposed. It is observed that said regression lines gradually have a cut-off point with the Y-axis at lower values, as the product drying phases progress. The slope of the lines also changes, and it is generally observed that the slope is greater in the initial drying phases, and lower in the final phases in which the product is already very dried.

In XYZ space, the current drying points HRr,TE,t are distributed on bundles of lines, which change their inclination. It is possible that when there are a few sustained points at excessively high TE values (very strong evaporation), this fact is then reflected in a subsequent decrease in the values of TEmax (symptom of the “crusting” defect).

The comparison of these regression lines of the graph (800) and their lateral traces on the planes, can allow the comparison with the example of a standard process. The appearance in the partial traces of points or segments that move away from the standard trace, may indicate that anomalous conditions are occurring that shall be reviewed in the process, such as the anomalous decrease of TEmax due to the appearance of crusting, or either low TEmax values related to other factors such as the use of DFD (dark firm dry) meats, high pHs of the meat emulsion, or for example related to poor fermentation that does not adequately lower the pH of the meat emulsion.

1. Method for estimating the surface water activity aws of a product being dried in a dryer comprises at least one relative humidity HR probe of the dryer atmosphere, the process comprises the following steps carried out by computational means:
obtaining by means of the at least one relative humidity HR probe a set of relative HRi humidity values of the dryer atmosphere at time points ti during the product drying process;
obtaining a set of HRᵣᵢ (%) representative values based on the relative humidity HRi values during the drying process of the product;
obtaining a set of evaporation rate values TEᵢ based on the set of HRi and ti values;
obtaining the regression line of the function F(α,β)=F(HRri, TEᵢ), such that::
$$α = HReq , β = 0$$
$$β = TE máx , α = 0$$
wherein HReq is the relative humidity when the air and the surface of the product being dried are in equilibrium,
wherein TEmáx is the maximum evaporation rate when HR of the air of the dryer is zero, and
estimating the value of aws of the product being dried based on HReq, such that:
$$aws = \frac{HReq}{100}$$

2. The method according to claim 1, wherein the set of representative values of relative humidity HRᵣᵢ (%) corresponds to:
$${HR}_{ri} ( \% ) = ( {HR}_{i} + {HR}_{i + 1} ) / 2$$

3. The method according to claim 1, wherein the set of representative values of relative humidity HRᵣᵢ (%) corresponds to:
$${HR}_{ri} ( \% ) = {HR}_{i} ;$$
$$or$$
$${HR}_{ri} ( \% ) = {HR}_{i + 1}$$

4. The method according to claim 1, wherein the set of representative values of relative humidity HRᵣᵢ (%)corresponds to:
$${HR}_{ri} ( \% ) = Me ( {HR}_{i} + {HR}_{i + 1} … {HR}_{i + N} ) ;$$
Wherein Me is the arithmetic mean of (N+1) data.

5. The method according to claim 1, wherein obtaining a set of evaporation rate values TE corresponds to:
$${TE}_{i} = ( {HR}_{i + 1} - {HR}_{i} ) / ( {t}_{i + 1} - {t}_{i} ) ; o$$
$${TE}_{i} = ( H {abs}_{i + 1} - H {abs}_{i} ) / ( {t}_{i + 1} - {t}_{i} ) .$$

6. Dryer for estimating the surface water activity aws of products being dried, wherein the dryer comprises at least one relative humidity HR probe of the dryer atmosphere, and characterized in that it comprises computational media configured for:
obtaining by means of the at least one relative humidity HR probe a set of relative HRi humidity values of the dryer atmosphere at time points during the product drying process;
obtaining a set of representative values HRᵣᵢ (%) based on the relative humidity HRi values during the product drying process
obtaining a set of evaporation rate TEᵢ values based on the set of HRi and ti values
obtaining the regression line of the function F(α,β)=F (HRri,TEᵢ), such that:
$$α = HReq , β = 0$$
$$β = TE máx , α = 0$$
wherein HReq is the relative humidity when the air and the surface of the product being dried are in equilibrium,
wherein TEmáx is the maximum evaporation rate if HR of the dryer air were zero, and
estimating the aws value of the product being dried based on HReq, such that:
$$aws = \frac{HReq}{100}$$

7. Method for estimating the surface water activity aws of a product being dried in a dryer comprises at least a temperature probe and one relative humidity HR probe of the dryer atmosphere, the process comprises the following steps carried out by computational means:
obtaining by means of the probes a set of temperature T and relative HRi humidity values of the dryer atmosphere at time points ti during the product drying process;
obtaining from the set of values of temperature T and relative HRi, the set of values of absolute Habs; humidity values of the dryer atmosphere at time points ti during the product drying process;
obtaining a set of HRᵣᵢ (%) representative values based on the relative humidity HRi values during the drying process of the product;
obtaining a set of evaporation rate values TEᵢ based on the set of Habsᵢ and ti values
obtaining the regression line of the function F(α,β)=F(HRri,TEᵢ), such that::
$$α = HReq , β = 0$$
$$β = TE máx , α = 0$$
wherein HReq is the relative humidity when the air and the surface of the product being dried are in equilibrium,
wherein TEmáx is the maximum evaporation rate when HR of the air of the dryer is zero, and
estimating the value of aws of the product being dried based on HReq, such that:
$$aws = \frac{HReq}{100}$$

8. The method according to claim 7, wherein the set of representative values of relative humidity HRᵣᵢ (%) corresponds to:
$${HR}_{ri} ( \% ) = ( {HR}_{i} + {HR}_{i + 1} ) / 2$$

9. The method according to claim 7, wherein the set of representative values of relative humidity HRᵣᵢ (%) corresponds to:
$${HR}_{ri} ( \% ) = {HR}_{i} ;$$
$$or$$
$${HR}_{ri} ( \% ) = {HR}_{i + 1}$$

10. The method according to claim 7, wherein the set of representative values of relative humidity HRᵣᵢ (%)corresponds to:
$${HR}_{ri} ( \% ) = Me ( {HR}_{i} + {HR}_{i + 1} … {HR}_{i + N} ) ;$$
Wherein Me is the arithmetic mean of (N+1) data.

11. The method according to claim 7, wherein obtaining a set of evaporation rate values TE corresponds to:
$${TE}_{i} = ( {HR}_{i + 1} - {HR}_{i} ) / ( {t}_{i + 1} - {t}_{i} ) ; or$$
$${TE}_{i} = ( H {abs}_{i + 1} - H {abs}_{i} ) / ( {t}_{i + 1} - {t}_{i} ) .$$

12. Dryer for estimating the surface water activity aws of products being dried, wherein the dryer comprises at least one relative humidity HR probe of the dryer atmosphere and a temperature probe, characterized in that it comprises computational media configured for:
obtaining by means of the probes a set of temperature T and relative HRi humidity values of the dryer atmosphere at time points ti during the product drying process;
obtaining from the set of values of temperature T and relative HRi, the set of values of absolute Habsᵢ humidity values of the dryer atmosphere at time points ti during the product drying process;
obtaining a set of HRᵣᵢ (%) representative values based on the relative humidity HRi values during the drying process of the product;
obtaining a set of evaporation rate values TEᵢ based on the set of Habsᵢ and ti values;
obtaining the regression line of the function F(α,β)=F(HRri,TEᵢ), such that::
$$α = HReq , β = 0$$
$$β = TE máx , α = 0$$
wherein HReq is the relative humidity when the air and the surface of the product being dried are in equilibrium,
wherein TEmáx is the maximum evaporation rate when HR of the air of the dryer is zero, and
estimating the value of aws of the product being dried based on HReq, such that:
$$aws = \frac{HReq}{100}$$
